(19) United States
(12) Patent Application Publication
(10) Pub. No.: US 2025/0346274 A1
(43) Pub. Date: Nov. 13, 2025

(54) PULL CART WITH ADJUSTABLE RODS FOR STORING AND TRANSPORTING CABLE REELS

(71) Applicant: Envision Tools, LLC, Eagle Mountain, UT (US)

(72) Inventor: Jonathan Pitts, Eagle Mountain, UT (US)

(73) Assignee: Envision Tools, LLC, Eagle Mountain, UT (US)

(21) Appl. No.: 18/657,692

(22) Filed: May 7, 2024

(51) Int. Cl. B62B 3/10; B62B 3/02

(52) U.S. Cl. CPC B62B 3/10; B62B 3/02

(57) ABSTRACT

Pull carts configured for holding, transporting, and storing reels of wire or cable. A cart includes a base comprising a plurality of base sidewalls and a plurality of support beams, wherein each of the plurality of support beams is attached to at least one of the plurality of base sidewalls. The cart includes a plurality of crossbar supports disposed on each of the plurality of support beams. The cart includes a crossbar, wherein the crossbar is supported by two or more of the plurality of crossbar supports, and wherein a position of the crossbar is adjustable based on which two or more of the plurality of crossbar supports is selected for supporting the crossbar.

### TECHNICAL FIELD

The present disclosure relates generally to pull carts, and in particular pull carts for transporting and storing wiring or cabling.

### BACKGROUND

Pull carts include various hand-operated carts that may be used to transport a variety of items, such as tools, materials, and equipment. Pull carts are particularly useful in warehouses and constructions sites, where heavy or cumbersome materials must be transported and maneuvered through rooms and obstacles. Pull carts are manufactured with various configurations and typically include flatbeds and shelves for carrying items of assorted sizes. One of the main advantages of using a pull cart is that it helps reduce strain and fatigue associated with manually carrying heavy or cumbersome items over long distances. Pull carts are also generally easier to maneuver and navigate through narrow spaces than larger vehicles such as forklifts or trucks.

In some cases, pull carts are specifically used for holding and transporting wires, such as electrical wires, fiber optic cables, coaxial cables, multicore cables, flexible cables, and so forth. Some wires can be exceedingly heavy, cumbersome, and difficult to maneuver, and this is particularly true for wires used in outdoor construction projects and commercial building construction projects.

However, traditional pull carts are inadequate for transporting heavy wires, and present numerous issues, including issues relating to stability, capacity, maneuverability, and compatibility. Traditional pull carts have limited stability when used to carry heavy wires, and particularly if the cart is not specifically designed to handle the weight and unique geometry of wires. This causes the wires to fall off during transport, which can potentially injure surrounding workers. Additionally, traditional pull carts are not large enough to hold wires and lack the capacity to carry particularly thick or heavy lengths of wire. Traditional pull carts are difficult to maneuver through tight spaces when loaded with lengths of wire. Finally, traditional pull carts are often incompatible with wire transport and do not provide adequate support or protection for the wire itself or the people transporting the pull cart.

In view of the foregoing, what is needed are improved pull carts specifically configured for holding and transporting wires. There is a need for a nimble, stable cart that can suit any job. Described herein are improved systems, apparatuses, and methods for transporting and storing wiring or cabling.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates a perspective view of an adjustable pull cart for storing and transporting reels;

FIG. 2 illustrates a straight-on side view of an adjustable pull cart for storing and transporting reels;

FIG. 3 illustrates a straight-on end view of an adjustable pull cart for storing and transporting reels;

FIG. 4 illustrates an underside view of an adjustable pull cart for storing and transporting reels;

FIG. 5 illustrates a top-down aerial view of an adjustable pull cart for storing and transporting reels;

FIG. 6A illustrates a perspective view of an adjustable pull cart for storing and transporting reels, wherein a plurality of crossbars are disposed through holes of the adjustable pull cart;

FIG. 6B illustrates a perspective view of an alternative adjustable pull cart for storing and transporting reels, wherein a plurality of crossbars are disposed through holes of the adjustable pull cart;

FIG. 7A illustrates a perspective view of an adjustable pull cart for storing and transporting reels, wherein a plurality of crossbars are disposed through holes of the adjustable pull cart, and a plurality of reels are stored on the crossbars;

FIG. 7B illustrates a perspective view of an alternative adjustable pull cart for storing and transporting reels, wherein a plurality of crossbars are disposed through holes of the adjustable pull cart, and a plurality of reels are stored on the crossbars;

FIG. 8A illustrates a straight-on side view of a reel spacer to be utilized with a cart configured for transporting a reel of wire or cable;

FIG. 8B illustrates a perspective view of a reel spacer to be utilized with a cart configured for transporting a reel of wire or cable;

FIG. 9 is a straight-on cross-sectional end view of a support beam to be utilized with a cart configured for transporting a reel of wire or cable;

FIG. 10 is a perspective view of a support beam to be utilized with a cart configured for transporting a reel of wire or cable;

FIG. 11 of a support beam to be utilized with a cart configured for transporting a reel of wire or cable;

FIG. 12 of a support beam to be utilized with a cart configured for transporting a reel of wire or cable;

FIG. 13A is a perspective view of a grommet to be utilized with a cart configured for transporting a reel of wire or cable;

FIG. 13B is a straight-on side view of a grommet to be utilized with a cart configured for transporting a reel of wire or cable;

FIG. 14A is a perspective view of a grommet disposed on a base crossbar;

FIG. 14B is a straight-on wide view of a grommet disposed on a base crossbar; and

FIG. 15 illustrates a perspective view of a cart configured for transporting a reel of wire or cable, wherein a plurality of flexible grommets are installed on the cart to prevent base crossbars from moving when transporting the cart.

### DETAILED DESCRIPTION

Described herein are improved apparatuses, systems, and methods for holding, transporting, and storing lengths of wire or cable. Specifically described herein is an adjustable pull cart that can be quickly and conveniently modified by an end-user to accommodate varied sizes of reels, different lengths of wire, and different wire weights. A cart described herein includes a base comprising a plurality of base sidewalls. The cart includes a plurality of support beams, wherein each of the plurality of support beams is attached to at least one of the plurality of base sidewalls. The cart includes a plurality of crossbar supports disposed on each of the plurality of support beams. The cart includes a crossbar, wherein the crossbar is supported by two or more of the plurality of crossbar supports. The cart is such that a position of the crossbar is adjustable based on which two or more of the plurality of crossbar supports is selected for supporting the crossbar.

In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure.

Before the methods, systems, and devices for producing a wire frame pull cart are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular implementations only and is not

intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

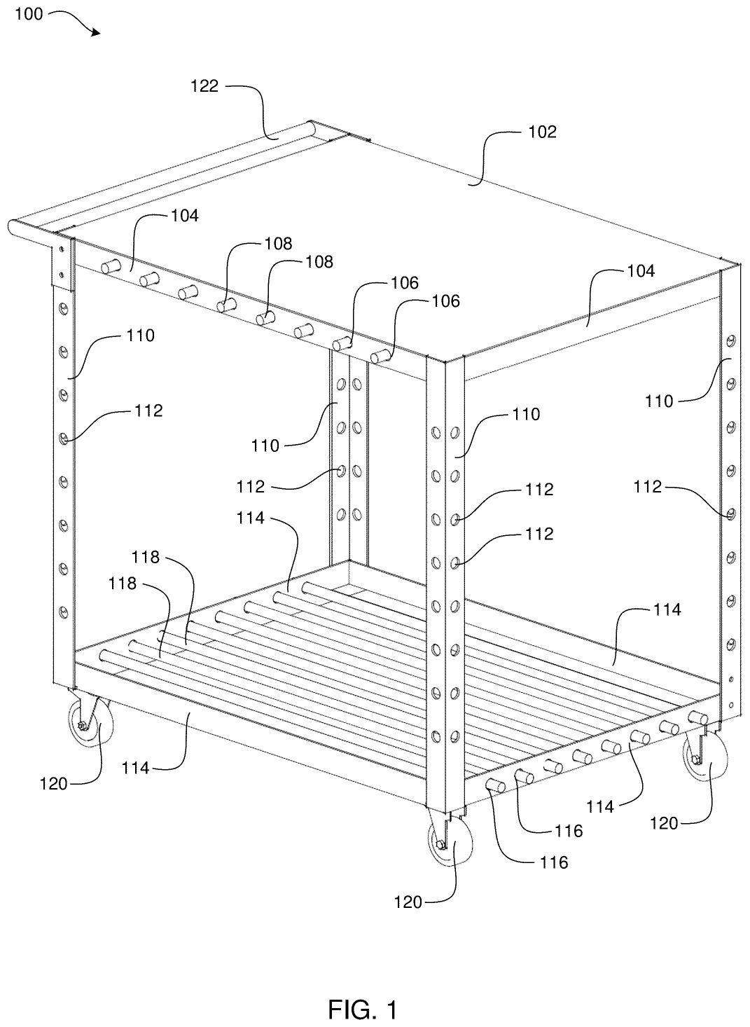

Referring now to the figures, FIGS. 1-7 illustrates various views and configurations of an adjustable pull cart 100. The cart 100 is configured for storing and transporting reels of wire or cable. The configuration of the cart 100 may be easily and quickly adjusted and optimized by a user to ensure proper spacing for storing varying sizes of reels and storing varying lengths of wire or cable.

The cart 100 may specifically be implemented to hold, transport, and store reels of wire or cable that may be particularly heavy and cumbersome to maneuver. The cart 100

represents an improvement over traditional wire pull carts, which are known to be difficult to maneuver and lack quick adjustability. The cart 100 described herein is specifically configured to be easily adjustable by the end user to optimize the spacing between crossbars for storing varying sizes of reels.

FIG. 1 is a perspective view of the cart 100 without crossbars installed in support beams of the cart 100. The cart 100 includes a top platform 102 that includes a plurality of top sidewalls 104. At least two of the top sidewalls 104 includes a plurality of top crossbar supports 106 disposed therethrough. The cart 100 includes a plurality of top crossbars 108 disposed through the top crossbar supports 106. In the implementation illustrated in FIG. 1, each of the top crossbars 108 is disposed through a first crossbar hole 106 at one end and is disposed through a second crossbar hole (not illustrated) on an opposite end.

The cart 100 includes a plurality of support beams 110 attached to the top platform 102 and/or one or more of the top sidewalls 104. The number of support beams 110 will determine the geometry of the cart 100 and the geometry of the top platform 102. In the implementation illustrated in FIG. 1, the cart 100 includes four support beams 110 and the top platform 102 includes a quadrilateral geometry. Each of the support beams 110 includes a plurality of crossbar supports 112 disposed therethrough. As shown in FIG. 1, each of the support beams 110 may include a bent cross-sectional geometry, such that a cross-section of the support beam 110 includes an L-shape. The support beams 110 may include crossbar supports 112 through each of the two sides of the bent support beam 110 geometry, as shown in FIG. 1. A user may utilize the crossbar supports 112 to optimize the location of crossbars (not shown in FIG. 1).

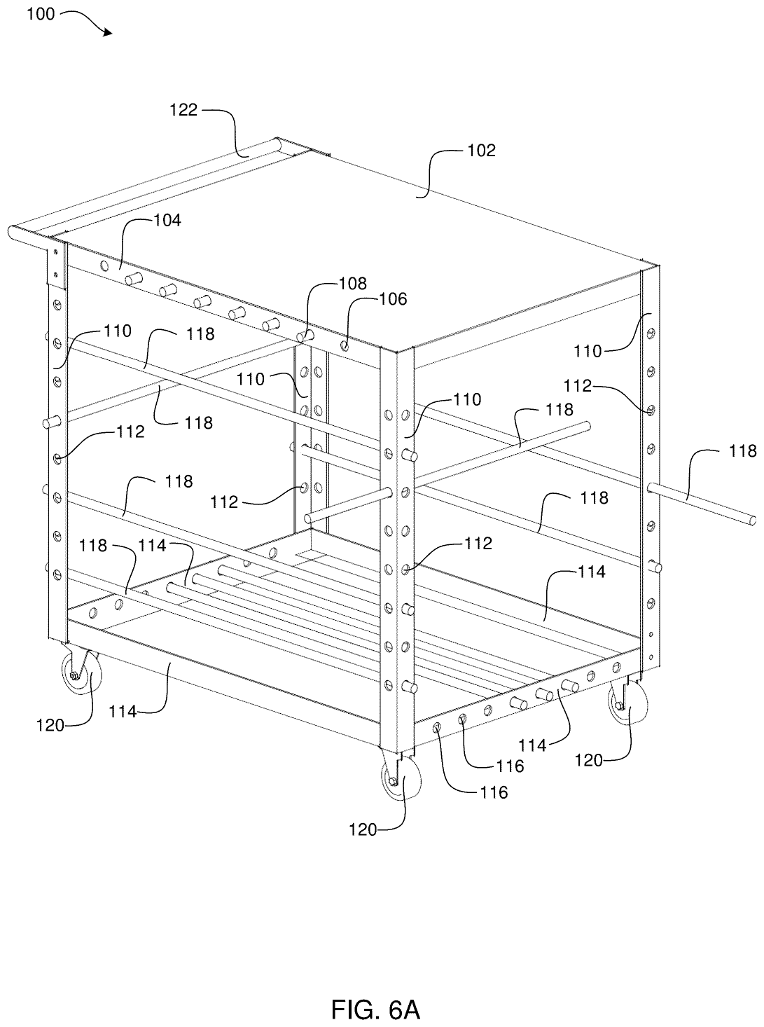

The crossbar supports 112 are configured for receiving, stabilizing, and supporting a crossbar. It will be appreciated that there may be crossbars of substantially equivalent length and/or crossbars that may be of differing lengths, which may be used to accommodate various dimensions of the cart. For example, in one implementation shown in FIG. 6A, the crossbars are of substantially equivalent length. In another implementation shown in FIG. 6B, the crossbars may be of differing lengths noted by the side reel crossbars 624 and end reel crossbars 626. In some implementations, the crossbar supports 112 consist of a through-hole machined into the support beam 110 itself, such that the crossbar supports 112 comprise a hole extending the entire thickness of the support beam 110. In other implementations, the crossbar supports 112 consist of a crossbar support machined into the support beams 110. The dimension of the crossbar support is optimized to enable the corresponding crossbar (see, e.g., 624 and 626 at FIG. 6B) to securely rest within the crossbar support.

The cart 100 includes a base that comprises a plurality of base sidewalls 114. The base further includes a plurality of base crossbar supports 116 disposed through one or more of the base sidewalls 114. The base further includes a plurality of base crossbars 118, wherein each of the plurality of base crossbars 118 is disposed through two or more of the base crossbar supports 116.

The cart 100 includes a handle 122 attached to one or more of the top platform 102, one or more of the support beams 110, or one or more of the top sidewalls 104. A user may utilize the handle 122 to pull and push the cart.

The cart 100 includes a plurality of wheels 120. The number of wheels 120 may be equivalent to the number of support beams 110. The wheels 120 are attached to one or more of a support beam 110 or one or more of the base sidewalls 114. The cart 100 may additionally include wheel brakes associated with the wheels 120. The wheels 120 enable easy transport and storage of the cart 100.

In addition to providing support and stability, the base portion of the cart 100 plays a role in maneuverability of the cart 100. The design of the base portion, including the size and position of the wheels 120, impacts how easily the cart 100 can be steered and turned. For example, carts 100 with larger wheels 120 may be better suited for rough terrain or uneven surface, while carts with smaller wheels 120 may be more maneuverable in tight spaces.

The support beams 110 may be solid or hollow three-dimensional constructs in some implementations while in others they may instead be formed from two substantially flat pieces of metal or other material joined at an angle as shown in FIG. 1. One or more of the crossbar supports 112 is disposed along a length of the support beams 110. In implementations where the support beams 110 are three-dimensional constructs, the crossbar supports 112 may extend all the way through the support beams 110 or may only be disposed along one side.

The base portion includes a plurality of base sidewalls 114, and the quantity of base sidewalls 114 will depend on the desired geometric configuration for the cart 100. In the example implementation illustrated in FIG. 1, the base portion includes four base sidewalls 114 for forming a quadrilateral (specifically rectangular) geometric configuration. The quantity of base sidewalls 114 may be adjusted such that the base portion includes three base sidewalls 114 for forming a triangular configuration, five base sidewalls 114 for forming a pentagonal configuration, six base sidewalls 114 for forming a hexagonal configuration, and so forth.

The base portion includes one or more base crossbar supports 116 disposed through the base sidewalls 114. The base crossbar supports 116 are configured for receiving, stabilizing, and supporting a base crossbar 118, as shown in FIG. 1. In some implementations, the base crossbar supports 116 consist of a through-hole machined into the base sidewall 114 itself, such that the base crossbar supports 116 comprise a hole extending the entire thickness of the base sidewall 114. In other implementations, the base crossbar supports 116 consist of a crossbar support machined into the base sidewall 114. The dimension of the crossbar support is optimized to enable the corresponding base crossbar 118 to securely rest within the crossbar support.

The base crossbars 118 are configured to be received and supported by the base crossbar supports 116. In most implementations, the geometries, and dimensions of the base crossbars 118 and the base crossbar supports 116 are optimized such that the base crossbar 118 and the base crossbar supports 116 form a tight interference fit. The lengths of the base crossbars 118 correspond with the lengths of the base sidewalls 114 such that a base crossbar 118 may reach from one base sidewall 114 having base crossbar supports 116 to an opposing base sidewall 114 having base crossbar supports 116 to secure the base crossbar 118 in position. In some implementations, a base crossbar 118 is sized to fit flush between two base crossbar supports 116 that are located opposite one another. In another implementation, the base crossbar 118 is slightly longer such that the base crossbar 118 extends through an entirety of a through-hole of the base crossbar supports 116, and thus protrudes out relative to an exterior wall of the base sidewall 114, as shown in FIG. 1. One or more base crossbars 118 may be freely inserted or withdrawn from a base portion through one or more base crossbar supports 116.

The base portion includes any number of base crossbars 118 as desired based on, for example, the overall dimensions of the base portion, the intent for using the base crossbars 118 (e.g., whether the base crossbars 118 will form a shelf or support for carrying items), and the anticipated weight or load to be carried by the cart 100.

The frame portions of the cart 100 (including, e.g., at least the base sidewalls 114, the support beams 110, and the top sidewalls 104) are manufactured with a rigid material such as steel, aluminum, rigid polycarbonate, wood, or composite materials such as fiberglass or carbon fiber. The choice of material for manufacturing the cart 100 depends on numerous factors such as the intended use of the cart, the anticipated weight of the wire pool to be transported, the environment in which the cart 100 will be used, and budgetary considerations.

The cart 100 is designed to be balanced such that the weight of reels are evenly distributed over the wheels 120. This prevents the cart 100 from tipping over when transported or when wire is unwound from a reel. Additionally, the cart 100 includes a storage region built into the base portion, where additional weight may be added as necessary to improve overall stability of the cart. In some cases, a bag of sand, container filled with water, or other weight may be disposed on the base portion to provide additional weight and stability when a crossbar (not shown in FIG. 1) holds a particularly heavy wire or cable.

The sizes and materials utilized for the wheels 120 of the cart are selected based on the intended use of the cart. In some cases, the cart 100 is configured with larger wheels that provide increased stability and maneuverability over uneven terrain. In other cases, the cart 100 may be configured with wheels 120 that primarily prioritize a smooth ride when navigating over smooth terrain. The wheel brakes enable the cart 100 be parked on an incline or uneven surface to prevent the cart 100 from rolling away. The wheel brakes are also configured to prevent the cart 100 from rolling when wire is unwound from a reel installed on the crossbars.

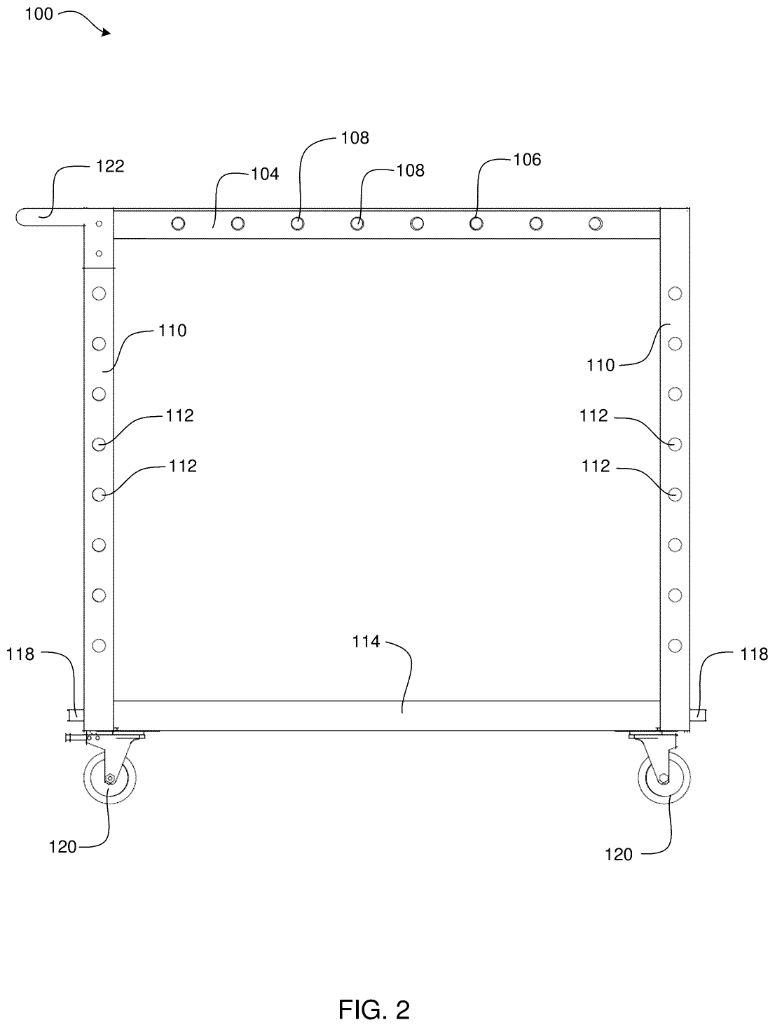

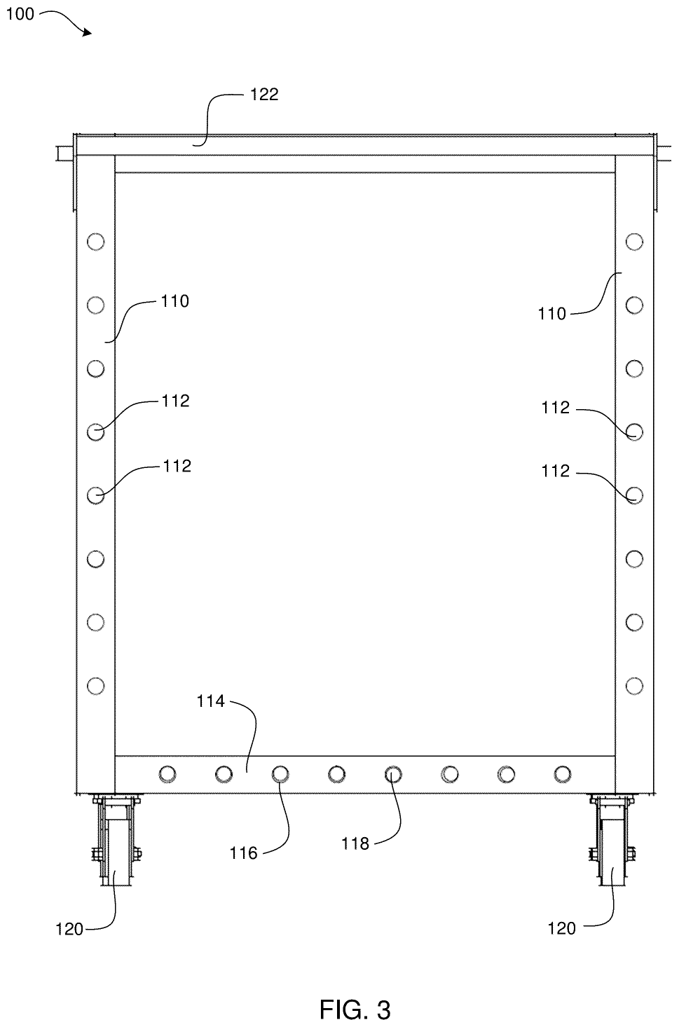

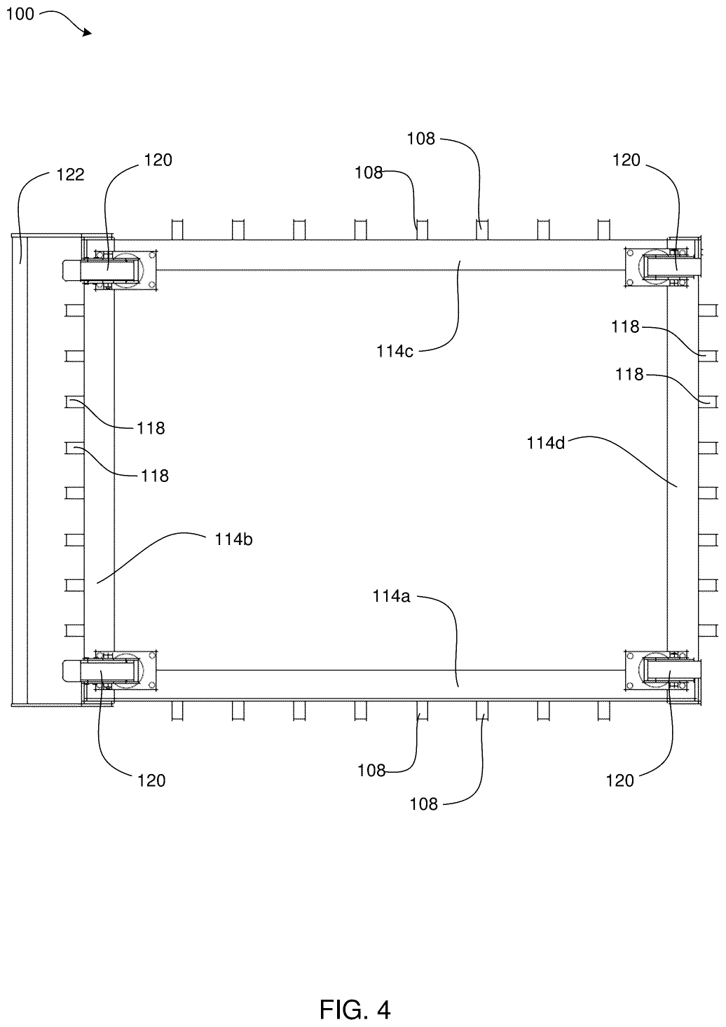

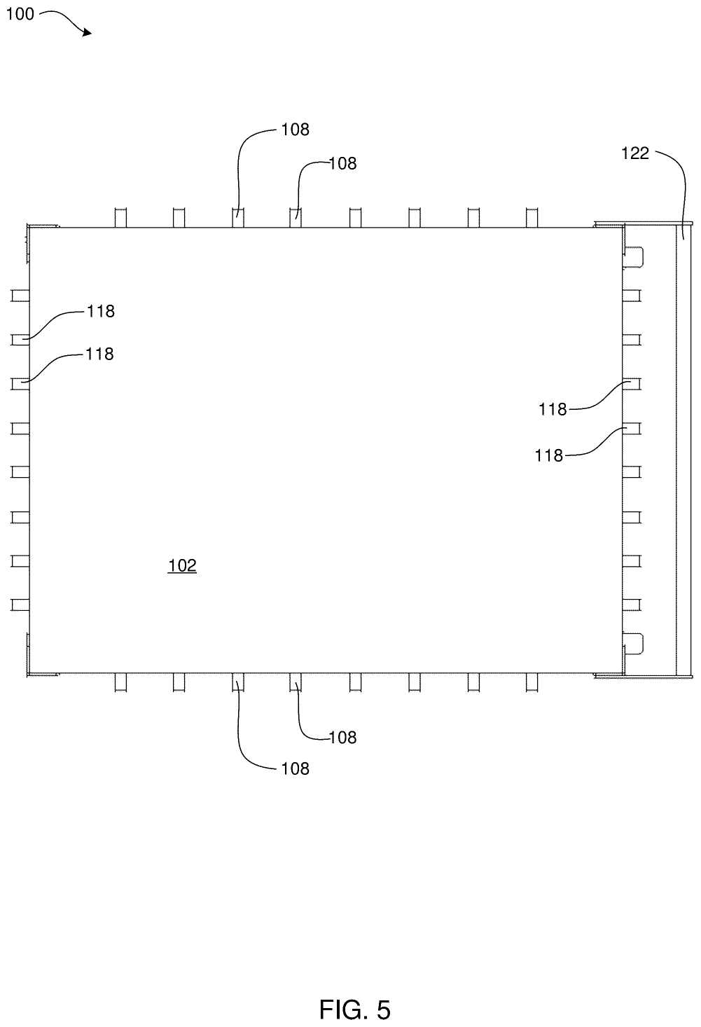

FIGS. 2-5 illustrate various views of the cart 100 without crossbars installed in the support beams of the cart 100. FIG. 2 illustrates a straight-on side view of the cart 100. FIG. 3 illustrates a straight-on end view of the cart 100. FIG. 4 illustrates a bottom-up underside view of the cart 100. FIG. 5 illustrates a top-down aerial view of the cart 100.

As shown in FIGS. 2 and 3, the support beams 110 include a bent cross-sectional geometry, and each of the two sides of the bent cross-sectional geometry includes crossbar supports 112 disposed therethrough. This enables a user to select which direction the crossbars (not illustrated) should be oriented. Because each support beam 110 includes two sets of crossbar supports that are oriented normal to each other, a user may orient the crossbars (not illustrated) in either of the two perpendicular directions. This increases the adjustability of the cart 100 and enables a user to optimize the space on the cart 100 for holding a maximum quantity of reels of wire or cable.

As shown in FIGS. 4 and 5, the top crossbars 108 are oriented perpendicular to the base crossbar supports 116. This improves the structure and stability of the cart 100. Additionally, this enables a user to store or transport items by placing them on the base crossbar supports 116, and additionally enables the user to store or transport items by hanging from the top crossbars 108.

Further as shown in FIG. 4, the base sidewalls 114 may include an L-section geometry, such that the base sidewalls 114 extend upward as shown in FIG. 1 and additionally extend parallel to the ground as shown in FIG. 4. The base sidewalls 114 may be referred to as a

first base sidewall 114a, a second base sidewall 114b, a third base sidewall 114c, and a fourth base sidewall 114d. It should be appreciated that the naming conventions applied to the base sidewalls in FIG. 4 are exemplary only, and do not necessarily correspond with the generic naming conventions applied to the base sidewalls in the claims. As shown in FIG. 4, the first base sidewall 114a is attached to the second base sidewall 114b at a right angle to form a first corner. The second base sidewall 114b is attached to the third base sidewall 114c at a right angle to form a second corner. The third base sidewall 114c is attached to the fourth base sidewall 114d at a right angle to form a third corner. The fourth base sidewall 114d is attached to the first base sidewall 114a at a right angle to form a fourth corner. A first support beam 110 (not shown) may be attached at the first corner, a second support beam 110 (not shown) may be attached at the second corner, a third support beam 110 (not shown) may be attached at the third corner, and a fourth support beam 110 (not shown) may be attached at the fourth corner. Further as shown, the length of the first base sidewall 114a and the third base sidewall 114c are substantially equivalent to one another form a longer side of the cart 100. Further, the lengths of the second base sidewall 114b and the fourth base sidewall 114d are substantially equivalent to one another to form a shorter side of the cart 100. It should be appreciated that the base may include varying geometries as determined by the number of base sidewalls, the lengths of the base sidewalls, and the arrangement of the base sidewalls. The exemplary arrangement in FIG. 4 creates a quadrilateral, and specifically a rectangular, geometry formed by the base sidewalls.

FIGS. 6A and 6B illustrate perspective views of the cart 100 with a plurality of crossbars installed or partially installed on the cart 100. FIG. 6A illustrates an implementation wherein the crossbars 118 are removed from the base and repurposed as “reel crossbars” to support a reel of wire or cable. FIG. 6B illustrates an implementation wherein reel crossbars 624, 626 are disposed through the crossbar supports 112 to support a reel of wire or cable. In the implementation illustrated in FIG. 6B, crossbars 118 could remain in the base, and additional reel crossbars 626, 626 may be utilized for supporting reels of wire or cable. As shown in FIGS. 6A and 6B, the crossbar supports 112 disposed through the support beams 110 enable a user to adjust and customize the cart 100 such that the user can store varying sizes of reels on the cart 100.

As shown in FIGS. 6A and 6B, the cart 100 includes a plurality of crossbars 118 and/or side reel crossbars 624 that may be used to cross the cart 100 lengthwise. These crossbars 118 and/or side reel crossbars 624 are oriented substantially perpendicular to the handle 122. The cart 100 may additionally include a plurality of crossbars 118 and/or end reel crossbars 626 that cross the cart 100 widthwise. The crossbars 118 and/or end reel crossbars 626 are oriented substantially parallel to the handle 122. The crossbars 118 and/or side reel crossbars 624 are configured to be disposed through a pair of crossbar supports 112 that are disposed through a side of a support beam 110 that is substantially parallel to the handle 122. The crossbars 118 and/or the end reel crossbars 626 are configured to be disposed through a pair of crossbar supports 112 are disposed through a side of a support beam 110 that is substantially perpendicular to the handle 122. The cart 100 is designed such that the crossbars 118 may be disposed through the crossbar supports 112 and thereby repurposed to support a reel of wire or cable. The cart 100 can therefore be utilized to conveniently store crossbars in the base or the crossbar supports 112.

The crossbars, 118, 624, 626 comprise a substantially cylindrical geometry and have an outer diameter that is smaller than an inner diameter of the crossbar supports 112. The outer diameters for the crossbars 118, 624, 626, and the inner diameters of the crossbar supports 112, may each be optimized such that the crossbars 118, 624, 626 for a tight interference fit within the crossbar supports 112. Alternatively, the respective diameters may be optimized such that the crossbars 118, 624, 626 may freely slide through the crossbar supports 112 to enable a user to easily remove and install the crossbar supports 112 to change the configuration of the cart 100.

The cart 100 may be configured to be used with varying reel crossbars 118, 624, 626 having different cross-sectional diameters. In an implementation, the dimension of a crossbar support 112 integrated into the support beam 110 is optimized based on a largest anticipated cross-sectional diameter for crossbars 118, 624, 626. In this implementation, additional size customizers may be disposed within the crossbar support 112 to reduce the size within the crossbar support 112, and thus enable the crossbar support 112 to snugly support one of the crossbars 118, 624, 626 having a smaller cross-sectional diameter. These additional size customizers may include, for example padding to be disposed within the crossbar support 112, rigid semi-circular supports to be clipped into the crossbar support 112 or otherwise releasably affixed to the crossbar support 112, and so forth.

The crossbar support 112 may have a circular geometry or semi-circular geometry. However, in additional implementations, the crossbar support 112 may additionally include a releasable clip or lever arm to close the crossbar support 112 and thus provide a complete circular geometry for the crossbar support 112. These releasable clips and/or lever arms may be implemented to lock the crossbars 118, 624, 626 into the crossbar support 112 and prevent the crossbars 118, 624, 626 from unintentionally lifting up and out of the crossbar support 112.

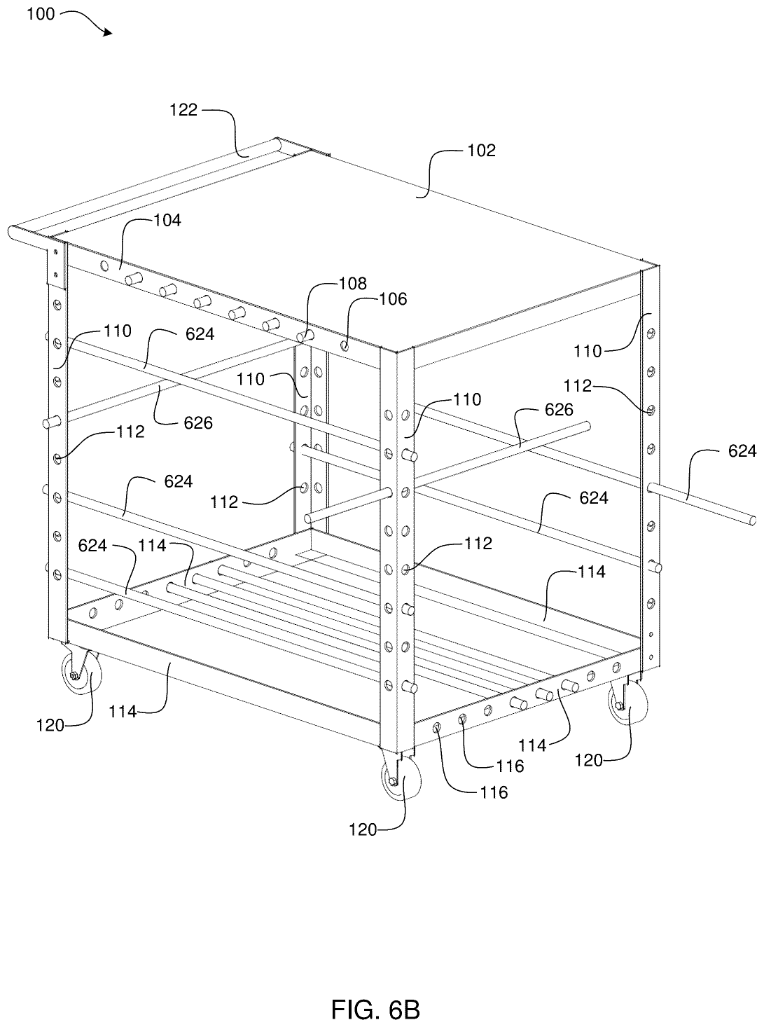

FIGS. 7A and 7B are perspective views of the cart 100 with a plurality of crossbars installed in the support beam of the cart. As shown in FIGS. 7A and 7B, multiple reels 720 for storing wire, cable, rope, chains, or other elongated materials, may be stored on the cart 100. Like FIG. 6A, FIG. 7A illustrates wherein crossbars 118 are removed from the base and slid into the crossbar supports 112 to serve as crossbars or reel crossbars. Further, like FIG. 6B, FIG. 7B illustrates wherein crossbars 624, 626 of different lengths may be utilized to support reels of wire or cable.

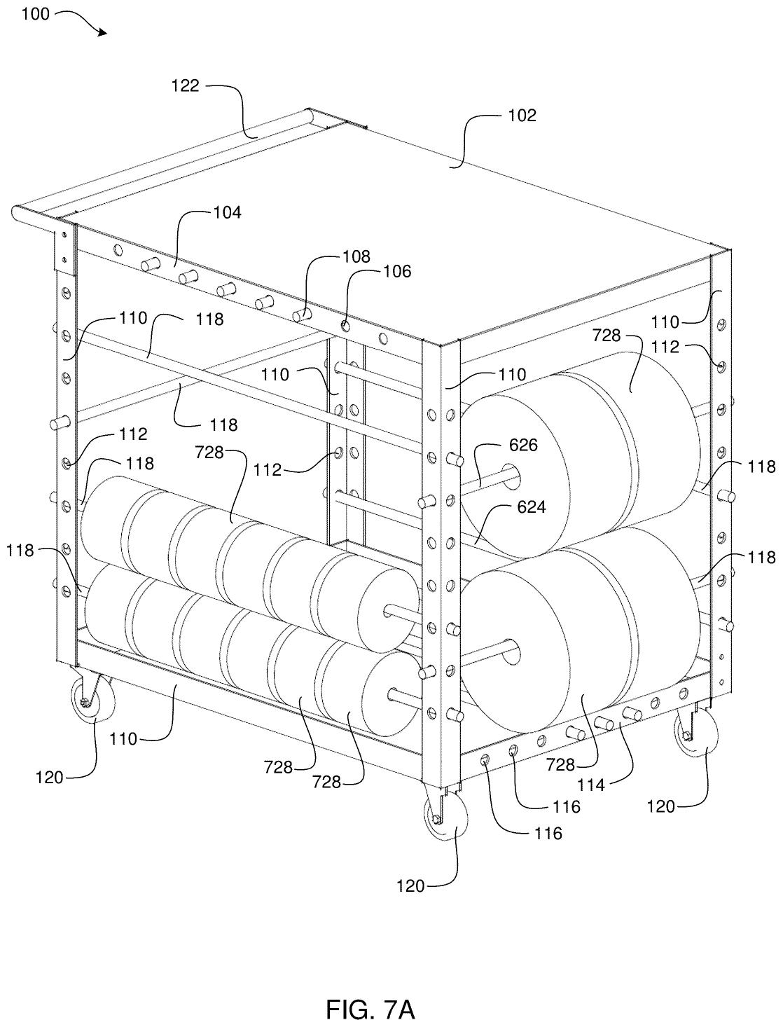

FIGS. 8A and 8B illustrate a reel spacer 800 that may be used with the cart 100 described herein. FIG. 8A is a straight-on side view of the reel spacer 800, and FIG. 8B is a perspective view of the reel spacer 800. The reel spacer 800 is utilized to provide space between separate reels or spools stored on the cart 100 and may additionally be utilized to provide space between a reel or spool and an end of the cart 100 itself. The reel spacer 800 prevents the separate reels from interacting with each other or the sides of the cart 100 and may be utilized to ensure the individual wires or cables round around the reels remain separated from one another. The reel spacer 800 is configured to slid on to a crossbar (see, e.g., 624, 626) of the cart.

The reel spacer 800 includes a substantially cylindrical body with a hollow interior, as shown in FIG. 8B. The reel spacer 800 includes two ends 802, including a first end and a second end that is opposite to the first end. The reel spacer 800 includes an interior reel spacer hole 804 which forms the hollow center of the substantially cylindrical body. The reel spacer 800 includes a side 806 with a curved surface. The side 806 includes a width 808, and the length of the width 808 is optimized depending on the amount of space desired between separate reels on the cart 100, or the amount of space desired between a reel and an end of the cart 100. The reel spacer 800 includes an internal diameter 810 measured across the internal sidewall that makes the hollow interior space of the reel spacer 800.

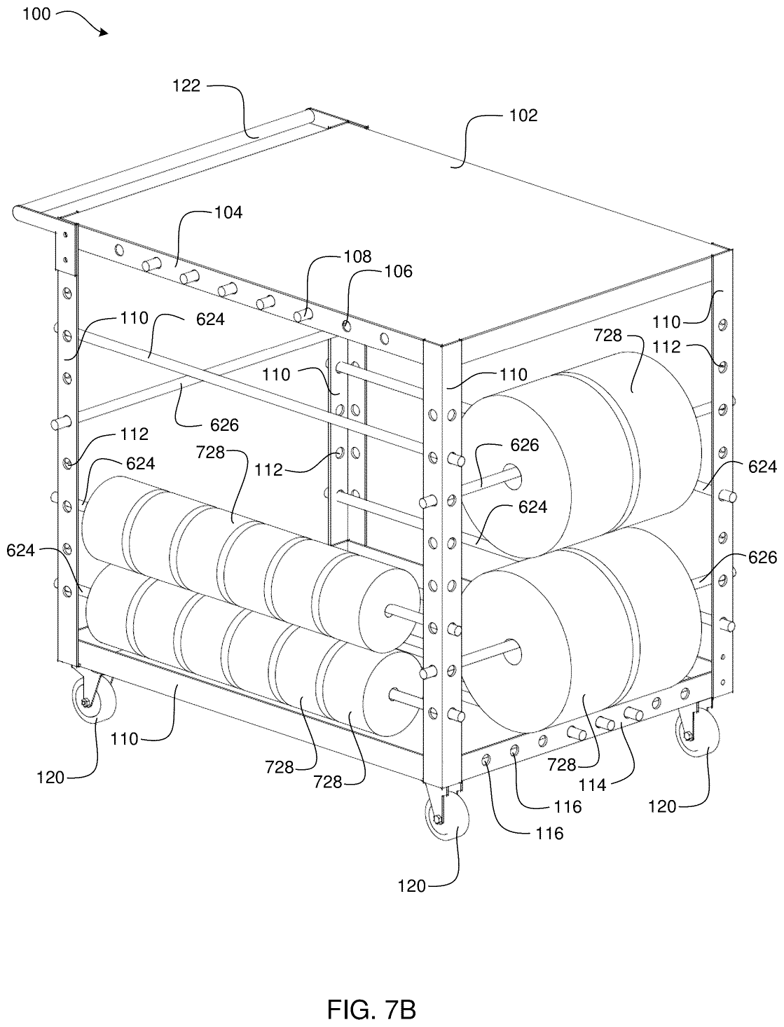

The reel spacer hole 804 is sized such that the crossbar (see, e.g., 106 at FIG. 1) is configured to receive the reel spacer 800. The internal diameter 810 of the reel spacer hole 804 is larger than an exterior diameter of the crossbar such that the reel spacer 800 may be easily slid on to the crossbar and thus installed or stored on the crossbar, as shown in FIG. 9.

The width 808 of the reel spacer 800 is optimized to providing sufficient space between two different reels for storing wire or cable. The width 808 is additionally optimized for providing sufficient space between a reel and a side of the cart 100.

The reel spacer 800 is manufactured from a substantially rigid material. The reel spacer 800 may specifically be manufactured with one or more of a polycarbonate material, metal, metal alloy, wood, and so forth.

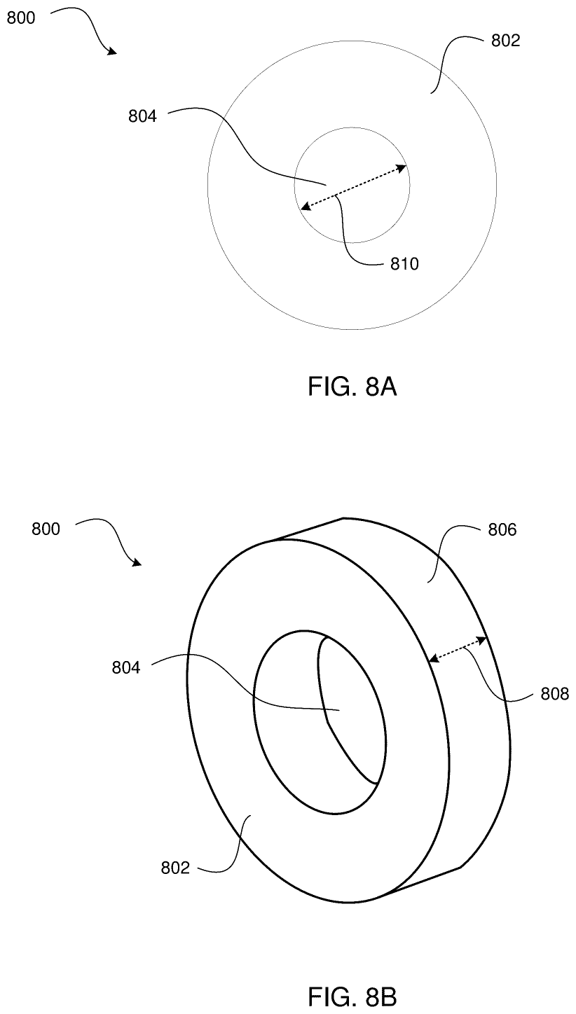

FIGS. 9-12 illustrate various views and various embodiments of a support beam 110 as described herein. FIG. 9 is a straight-on cross-sectional end view of the support beam 110, illustrating the L-section geometry of the support beam 110. FIGS. 10-12 are perspective view of varying embodiments of a support beam.

The support beam 110 includes a L-shaped cross-sectional geometry, which may be referred to as an “L-section” geometry as described herein. The support beam 110 includes a first side 902 and a second side 904 as shown in FIG. 9, wherein the first side 902 is substantially perpendicular to the second side 904. The widths of the first side 902 and the second side 904 may be substantially equivalent as shown in FIG. 9. In alternative implementations, the widths of the first side 902 and the second side 904 may be different. The first side 902 and the second side 904 of the support beam are attached to different base sidewalls (see 114) of the base, as shown at least in FIG. 1.

The support beams 110 are arranged such that the cart 100 will include a first plurality of support beam sides that are substantially parallel to one another, and the cart will further include a second plurality of support beam sides that are substantially parallel to one another. The first plurality of support beam sides are substantially perpendicular to the second plurality of support beam sides. Each crossbar (see 118, 624, 626) will be disposed through a corresponding pair of crossbar supports (see 112). A corresponding pair of crossbar supports includes a first crossbar support and a second crossbar support that are disposed through different support beams 110 but are substantially parallel to one another. Thus, a corresponding pair of crossbar supports will include a first crossbar support that is disposed through a first side 902 of a first crossbar, and a second crossbar support that is disposed through a second side 904 of a second crossbar. The corresponding pair of crossbar supports are thus disposed through “opposite” sides of different support beams 110 but may still be parallel to one another due to the arrangement of support beams 110 on the cart, as shown at least in FIG. 1.

FIG. 10 is a perspective view of the support beam 110 that includes equal quantities of crossbar supports 112, and equal-sized crossbar supports 112 on each side 902, 904 of the support beam 110. This implementation of the support beam 110 is illustrated at least in FIG. 1 of the cart 100. However, the cart 100 may be implemented with varying support beam 110 implementations, including support beams that have different sized crossbar supports 112 on the two sides 902, 904 of the support beam 110, and/or implementations that have different quantities of crossbar supports 112 on the two sides 902, 904 of the support beam 110.

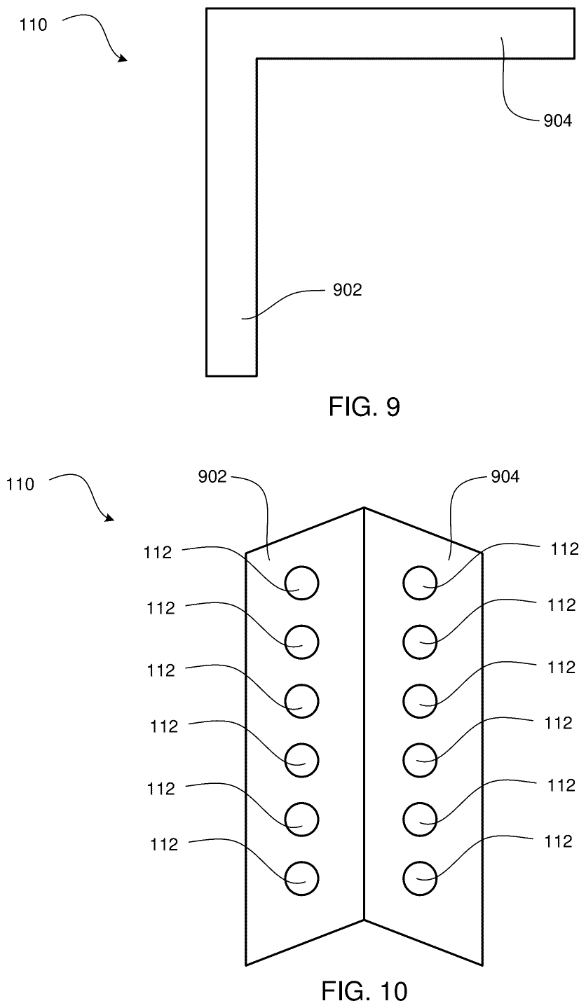

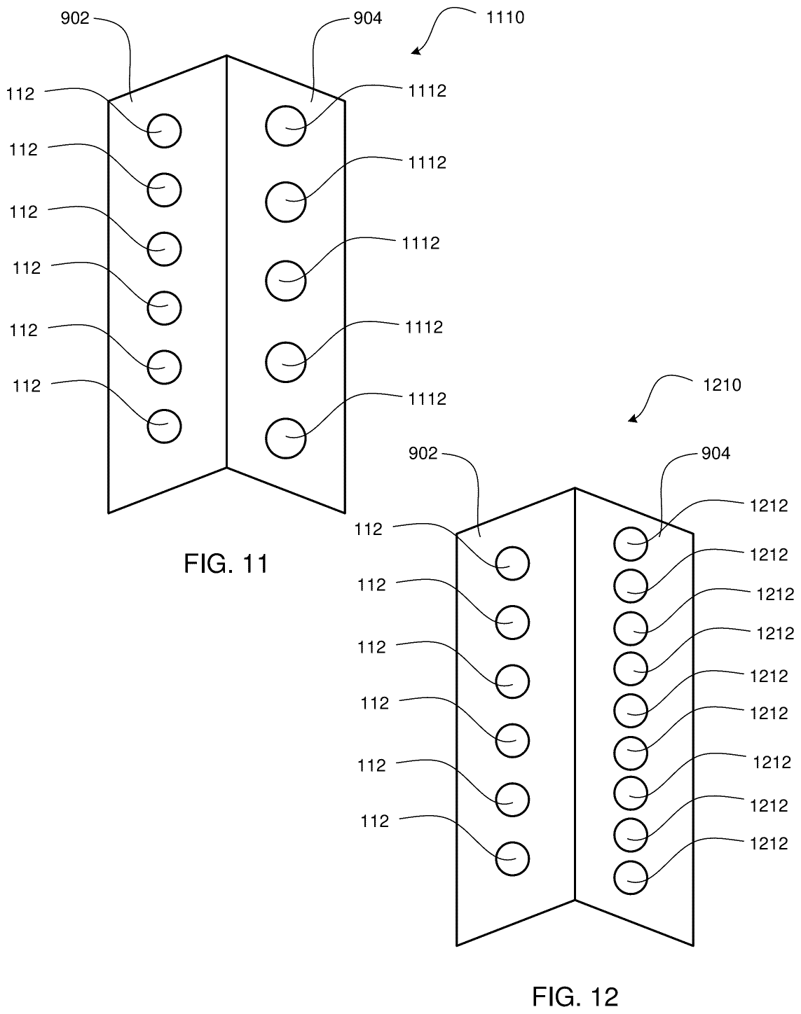

FIGS. 11 and 12 illustrate alternate implementations of the support beam. FIG. 11 illustrates a support beam 1110 wherein the first side 902 includes a first plurality of crossbar supports 112, and the second side 904 includes a second plurality of crossbar supports 1112. As shown in FIG. 11, the number of the first plurality of crossbar supports 112 is different than the number of the second plurality of crossbar supports 1112. Additionally, the diameter of the first plurality of crossbar supports 112 is smaller than the diameter of the second plurality of crossbar supports 1112.

FIG. 12 illustrates a support beam 1210 wherein the first side 902 includes a first plurality of crossbar supports 112, and the second side 904 includes a second plurality of crossbar supports 1212. As shown in FIG. 11, the number of the first plurality of crossbar supports 112 is different than the number of the second plurality of crossbar supports 1212. Additionally, the diameter of the first plurality of crossbar supports 112 is smaller than the diameter of the second plurality of crossbar supports 1212.

It should be appreciated that the support beam 110 may be implemented with varying numbers and sizes of crossbar supports 112. The number and size of crossbar supports 112 may be optimized depending on the intended sizes and weights of reels to be stored and transported with the cart 100.

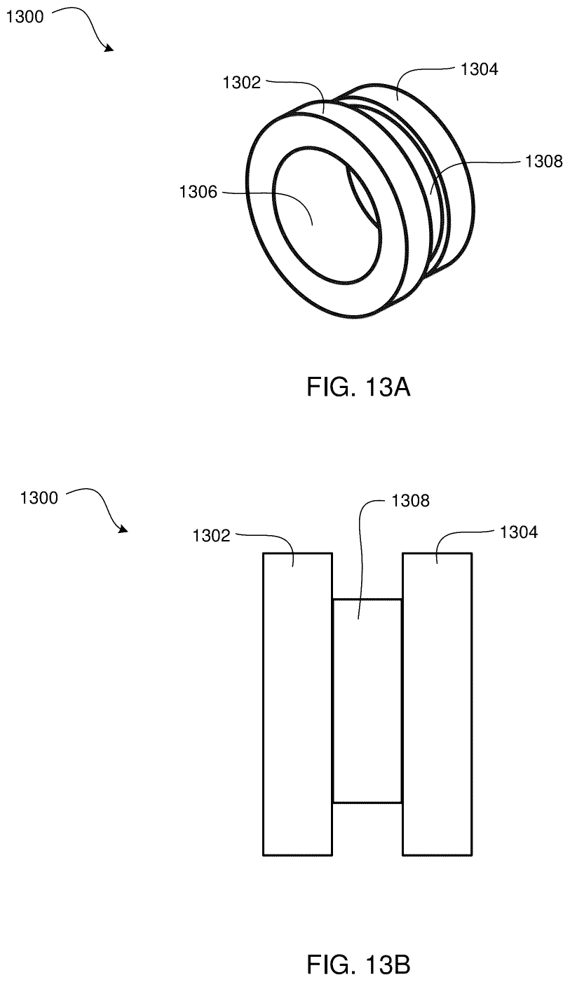

FIGS. 13A and 13B each illustrate a grommet 1300 for use with the cart described herein. FIG. 13A is a perspective view of the grommet 1300. FIG. 13B is a straight-on side view of the grommet 1300. The grommet 1300 is constructed of a flexible material such as rubber, foam, neoprene, or a flexible polycarbonate. The grommet 1300 is installed on the cart to ensure the base crossbars (see, e.g., 118) are secured in-place and do not rattle or create excessive noise when transporting the cart.

The grommet 1300 includes a first washer 1302 and a second washer 1304. The grommet 1300 includes a shank 1308 disposed in between the first washer 1302 and the second washer. A diameter of the shank 1308 is less than a diameter of either of the first washer 1302 or the second washer 1304. The grommet 1300 includes a shank interior surface 1306 that contacts an exterior surface of the base crossbars when the grommet 1300 is installed on the cart.

Because the grommet 1300 is constructed of a flexible material, the grommet 1300 may be bent or otherwise distorted by a user to press the grommet 1300 through a crossbar support (see, e.g., 116). When the grommet 1300 is pressed through the crossbar support, the first washer 1302 will be located on one side of a base sidewall (see, e.g., 114), and the second washer 1304 will be located on the opposite side of the sidewall. The shank 1308 is then disposed within the negative space defined by the crossbar support. The base crossbar may then be pressed into the interior space defined by the shank 1308 such that an exterior wall of the base crossbar contacts the shank interior surface 1306. The shank interior surface 1306 may form a tight interference fit against the exterior wall of the base crossbar and thereby hold the base crossbar in place and prevent the base crossbar from rattling against the sidewall when the cart 1300 is transported.

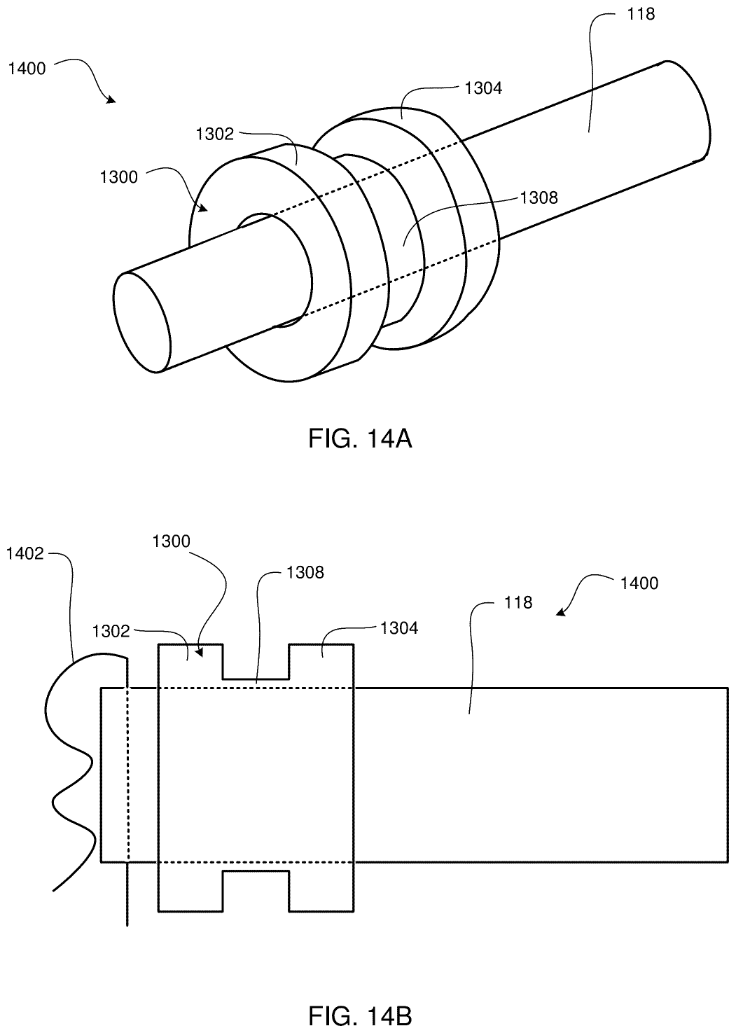

FIGS. 14A and 14B illustrate a system 1400 that includes the grommet 1300 installed on a base crossbar 118. FIG. 14A is a perspective view of the grommet 1300 slid on to the base crossbar 118. FIG. 14B is a straight-on wireframe side view of the grommet 1300 slid on to the base crossbar 118, wherein hidden components are illustrated with dotted lines.

As shown in FIG. 14B, the system 1400 may additionally include a fastener 1402 for preventing the base crossbar 118 from sliding out of the crossbar support (see, e.g., 504). The fastener 1402 may specifically include a hairpin cotter as shown in FIG. 14B or may alternatively include a different suitable fastener.

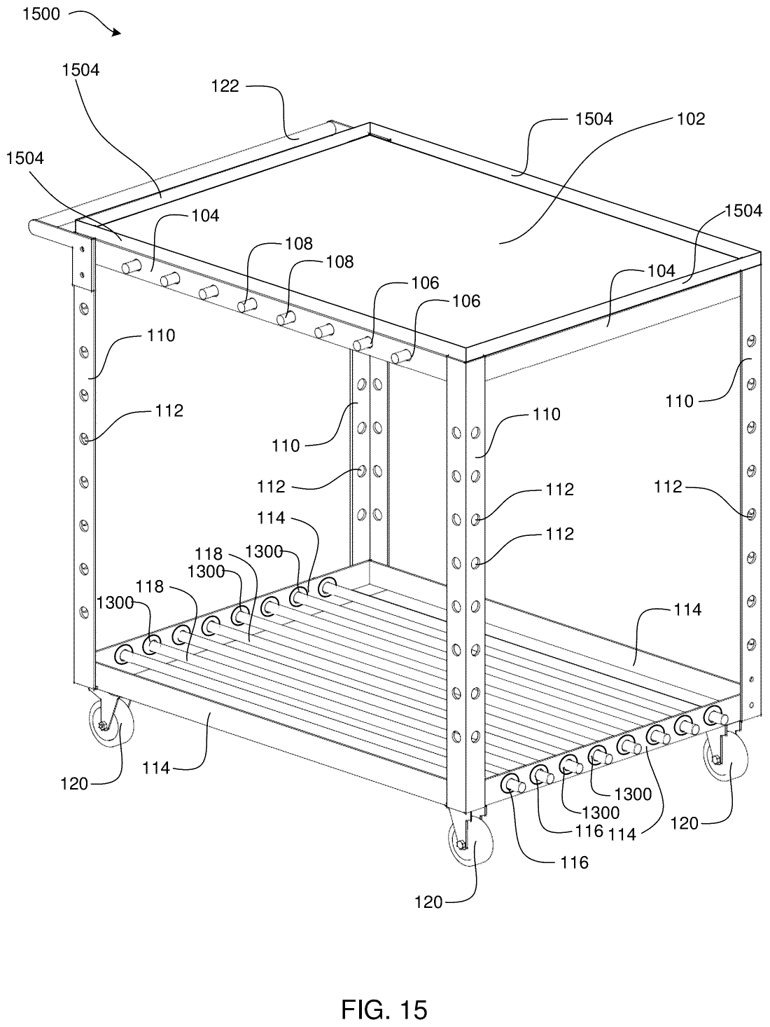

FIG. 15 illustrates a cart 1500 that includes a plurality of grommets 1300 installed within the base sidewall 114. The plurality of grommets 1300 secure the base crossbars 118 in place and prevent the base crossbars 118 from rattling when the cart 1500 is transported. The cart 1500 includes any of the features described in connection with the cart 100 first discussed and illustrated in connection with FIG. 1.

In an implementation illustrated in FIG. 15, the top platform 102 (see also FIG. 1) includes a plurality of tray sidewalls 1504 that extend above the surface of the top platform 102. These tray sidewalls 1504 form a recessed portion or a tray at the top of the cart 100 for easily storing items when transporting the cart 100, and for preventing those items from falling off the cart 100 during transport. In some implementations, the tray sidewalls 1504 are an extension of the top sidewalls 104 as illustrated in FIG. 15, such that the top sidewalls 104 extend downward relative to the top platform 102 (as shown in FIG. 15), and additionally extend upward relative to the top platform 102.

### EXAMPLES

The following examples pertain to further embodiments.

Example 1 is a cart. That cart includes a base comprising a plurality of base sidewalls. The cart includes a plurality of support beams, wherein each of the plurality of support beams is attached to at least one of the plurality of base sidewalls. The cart includes a plurality of crossbar supports disposed on each of the plurality of support beams. The cart includes a crossbar, wherein the crossbar is supported by two or more of the plurality of crossbar supports. The cart is such that a position of the crossbar is adjustable based on which two or more of the plurality of crossbar supports is selected for supporting the crossbar.

Example 2 is a cart as in Example 1, wherein each of the plurality of crossbar supports comprises a through-hole disposed through one of the plurality of support beams.

Example 3 is a cart as in any of Examples 1-2, wherein the crossbar comprises a circular cross-sectional geometry having an exterior diameter; wherein the exterior diameter of the crossbar is smaller than an interior diameter of the through-hole of the two or more of the plurality of crossbar supports such that a user may slide the crossbar through the two or more of the plurality of crossbar supports to install or remove the crossbar.

Example 4 is a cart as in any of Examples 1-3, further comprising a reel configured for holding a wire or cable, wherein the reel comprises an arbor hole disposed through a barrel; wherein the exterior diameter of the crossbar is sized such that the crossbar is disposed through the arbor hole of the reel for storing the reel on the crossbar of the cart; and wherein the exterior diameter of the crossbar is smaller than an interior diameter of the arbor hole of the reel.

Example 5 is a cart as in any of Examples 1-4, wherein the plurality of base sidewalls of the base are attached to one another to form a quadrilateral geometry; wherein a first support beam of the plurality of support beams is attached to two base sidewalls of the plurality

of base sidewalls at a first corner of the quadrilateral geometry; wherein a second support beam of the plurality of support beams is attached to two base sidewalls of the plurality of base sidewalls at a second corner of the quadrilateral geometry; wherein a third support beam of the plurality of support beams is attached to two base sidewalls of the plurality of base sidewalls at a third corner of the quadrilateral geometry; and wherein a fourth support beam of the plurality of support beams is attached to two base sidewalls of the plurality of base sidewalls at a fourth corner of the quadrilateral geometry.

Example 6 is a cart as in any of Examples 1-5, wherein each of the first support beam, the second support beam, the third support beam, and the fourth support beam comprises an L-section geometry; wherein, for each of the first support beam, the second support beam, the third support beam, and the fourth support beam, a first side of the L-section geometry is attached to a different base sidewall than a second side of the L-section geometry.

Example 7 is a cart as in any of Examples 1-6, wherein the base comprises four base sidewalls arranged in a quadrilateral geometry comprising four corners, and wherein the plurality of support beams comprises: a first support beam attached to a first base sidewall and a second base sidewall at a first corner of the four corners; a second support beam attached to the second base sidewall and a third base sidewall at a second corner of the four corners; a third support beam attached to the third base sidewall and a fourth base sidewall at a third corner of the four corners; and a fourth support beam attached to the fourth base sidewall and the first base sidewall at a fourth corner of the four corners.

Example 8 is a cart as in any of Examples 1-7, wherein the quadrilateral geometry of the base comprises a rectangular geometry such that: the first base sidewall and the third base

sidewall comprise substantially equivalent lengths and form a longer side of the cart; and the second base sidewall and the fourth base sidewall comprise substantially equivalent lengths and form a shorter side of the cart.

Example 9 is a cart as in any of Examples 1-8, wherein the crossbar comprises a plurality of crossbars, and wherein the plurality of crossbars comprises: a plurality of longer crossbars configured to be oriented substantially parallel to the longer side of the cart, wherein each of the plurality of longer crossbars is configured to be disposed through a corresponding pair of crossbar supports that are disposed through: the first support beam and the fourth support beam; or the second support beam and the third support beam; and a plurality of shorter crossbars configured to be oriented substantially parallel to the shorter side of the cart, wherein each of the plurality of shorter crossbars is configured to be disposed through a corresponding pair of crossbar supports that are disposed through: the first support beam and the second support beam; or the third support beam and the fourth support beam.

Example 10 is a cart as in any of Examples 1-9, wherein each of the plurality of support beams comprises an L-section geometry comprising a first side and a second side, wherein the first side is substantially perpendicular to the second side; wherein, for each of the plurality of support beams, the plurality of crossbar supports comprises: a first plurality of through-holes disposed through the first side of the L-section geometry; and a second plurality of through-holes disposed through the second side of the L-section geometry.

Example 11 is a cart as in any of Examples 1-10, wherein each of the first plurality of through-holes comprises a first inner diameter; and wherein each of the second plurality of through-holes comprises a second inner diameter.

Example 12 is a cart as in any of Examples 1-11, wherein the first inner diameter of the first plurality of through-holes is substantially equivalent to the second inner diameter of the second plurality of through-holes.

Example 13 is a cart as in any of Examples 1-12, wherein the first inner diameter of the first plurality of through-holes is different from the second inner diameter of the second plurality of through-holes.

Example 14 is a cart as in any of Examples 1-13, wherein the base further comprises a plurality of base crossbar supports; wherein each of the plurality of base crossbar supports comprises a through-hole disposed through one of the plurality of base sidewalls; wherein the base further comprises a plurality of base crossbars, wherein each of the plurality of base crossbars is supported by two or more of the plurality of base crossbar supports.

Example 15 is a cart as in any of Examples 1-14, further comprising a reel spacer, wherein the reel spacer comprises a substantially cylindrical geometry and further comprises a reel spacer hole disposed through the substantially cylindrical geometry, wherein the reel spacer hole of the reel spacer is configured to receive the crossbar.

Example 16 is a cart as in any of Examples 1-15, further comprising a top platform, wherein the top platform is attached to each of the plurality of support beams.

Example 17 is a cart as in any of Examples 1-16, further comprising a handle attached to one or more of the top platform or two of the plurality of support beams.

Example 18 is a cart as in any of Examples 1-17, further comprising a plurality of wheels, wherein a quantity of the plurality of wheels is equivalent to a quantity of the plurality of support beams.

Example 19 is a cart as in any of Examples 1-18, wherein the crossbar comprises a plurality of crossbars, and wherein a quantity of the plurality of crossbars installed on the cart is adjustable by a user.

Example 20 is a cart as in any of Examples 1-19, wherein a spacing between two or more of the plurality of crossbars is adjustable by the user.

Example 21 is a cart as in any of Examples 1-20, further comprising a reel spacer.

Example 22 is a cart as in any of Examples 1-21, wherein the reel spacer comprises a substantially cylindrical geometry; and wherein the reel spacer comprises a central hole disposed through a center of the substantially cylindrical geometry; and wherein the central hole is configured to receive the crossbar.

Example 23 is a cart as in any of Examples 1-22, wherein the reel spacer is disposed around the crossbar, and wherein the reel spacer is located in between two reels stored on the crossbar.

Example 24 is a cart as in any of Examples 1-23, wherein the reel spacer is manufactured of a rigid material comprising one or more of a polycarbonate material, a metal, a metal alloy, or wood.

Example 25 is a cart as in any of Examples 1-24, further including a flexible grommet.

Example 26 is a cart as in any of Examples 1-25, wherein the flexible grommet is manufactured of a flexible material, and wherein the flexible material is rubber.

Example 27 is a cart as in any of Examples 1-26, wherein the flexible grommet includes a shank, and wherein one of the plurality of base crossbars is disposed through an interior space defined by the shank of the flexible grommet.

Example 28 is a cart as in any of Examples 1-27, wherein the shank of the flexible grommet is disposed within a base crossbar support, and wherein the flexible grommet prevents the base crossbar from moving when the cart is transported.

Example 29 is a cart as in any of Examples 1-28, wherein the crossbar comprises a plurality of crossbars, and wherein a length of each of the plurality of crossbars is substantially equivalent.

Example 30 is a cart as in any of Examples 1-29, further comprising a top platform, wherein the top platform is attached to each of the plurality of support beams; wherein the top platform comprises a plurality of tray sidewalls that extend above a surface of the top platform thereby forming a recessed portion with the top surface for storing items when transporting the cart and for preventing those items from falling off the cart during transport.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so

described and illustrated. The scope of the disclosure is to be defined by the claims appended hereto, any future claims submitted here and in different applications, and their equivalents.

In the foregoing Detailed Description, various features of the disclosure are grouped together in a single implementation for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed implementation. Thus, the following claims are hereby incorporated into this Detailed Description by this reference, with each claim standing on its own as a separate implementation of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

What is claimed is:

1. A cart for storing and transporting a reel of wire or cable, the cart comprising:
a base comprising a plurality of base sidewalls; and
a plurality of support beams, wherein each of the plurality of support beams is attached to at least one of the plurality of base sidewalls;
a plurality of crossbar supports disposed on each of the plurality of support beams; and
a crossbar, wherein the crossbar is supported by two or more of the plurality of crossbar supports; and
wherein a position of the crossbar is adjustable based on which two or more of the plurality of crossbar supports is selected for supporting the crossbar.

2. The cart of claim 1, wherein each of the plurality of crossbar supports comprises a through-hole disposed through one of the plurality of support beams.

3. The cart of claim 2, wherein the crossbar comprises a circular cross-sectional geometry having an exterior diameter;
wherein the exterior diameter of the crossbar is smaller than an interior diameter of the through-hole of the two or more of the plurality of crossbar supports such that a user may slide the crossbar through the two or more of the plurality of crossbar supports to install or remove the crossbar.

4. The cart of claim 1, wherein the plurality of base sidewalls of the base are attached to one another to form a quadrilateral geometry;
wherein a first support beam of the plurality of support beams is attached to two base sidewalls of the plurality of base sidewalls at a first corner of the quadrilateral geometry;
wherein a second support beam of the plurality of support beams is attached to two base sidewalls of the plurality of base sidewalls at a second corner of the quadrilateral geometry;
wherein a third support beam of the plurality of support beams is attached to two base sidewalls of the plurality of base sidewalls at a third corner of the quadrilateral geometry; and
wherein a fourth support beam of the plurality of support beams is attached to two base sidewalls of the plurality of base sidewalls at a fourth corner of the quadrilateral geometry.

5. The cart of claim 4, wherein each of the first support beam, the second support beam, the third support beam, and the fourth support beam comprises an L-section geometry;
wherein, for each of the first support beam, the second support beam, the third support beam, and the fourth support beam, a first side of the L-section geometry is attached to a different base sidewall than a second side of the L-section geometry.

6. The cart of claim 1, wherein the base comprises four base sidewalls arranged in a quadrilateral geometry comprising four corners, and wherein the plurality of support beams comprises:
a first support beam attached to a first base sidewall and a second base sidewall at a first corner of the four corners;
a second support beam attached to the second base sidewall and a third base sidewall at a second corner of the four corners;
a third support beam attached to the third base sidewall and a fourth base sidewall at a third corner of the four corners; and
a fourth support beam attached to the fourth base sidewall and the first base sidewall at a fourth corner of the four corners.

7. The cart of claim 6, wherein the quadrilateral geometry of the base comprises a rectangular geometry such that:
the first base sidewall and the third base sidewall comprise substantially equivalent lengths and form a longer side of the cart; and
the second base sidewall and the fourth base sidewall comprise substantially equivalent lengths and form a shorter side of the cart.

8. The cart of claim 7, wherein the crossbar comprises a plurality of crossbars, and wherein the plurality of crossbars comprises:
a plurality of longer crossbars configured to be oriented substantially parallel to the longer side of the cart, wherein each of the plurality of longer crossbars is configured to be disposed through a corresponding pair of crossbar supports that are disposed through:
the first support beam and the fourth support beam; or
the second support beam and the third support beam; and
a plurality of shorter crossbars configured to be oriented substantially parallel to the shorter side of the cart, wherein each of the plurality of shorter crossbars is configured to be disposed through a corresponding pair of crossbar supports that are disposed through:
the first support beam and the second support beam; or the third support beam and the fourth support beam.

9. The cart of claim 1, wherein each of the plurality of support beams comprises an L-section geometry comprising a first side and a second side, wherein the first side is substantially perpendicular to the second side;
wherein, for each of the plurality of support beams, the plurality of crossbar supports comprises:
a first plurality of through-holes disposed through the first side of the L-section geometry; and
a second plurality of through-holes disposed through the second side of the L-section geometry.

10. The cart of claim 9, wherein each of the first plurality of through-holes comprises a first inner diameter; and
wherein each of the second plurality of through-holes comprises a second inner diameter.

11. The cart of claim 10, wherein the first inner diameter of the first plurality of through-holes is substantially equivalent to the second inner diameter of the second plurality of through-holes.

12. The cart of claim 10, wherein the first inner diameter of the first plurality of through-holes is different from the second inner diameter of the second plurality of through-holes.

13. The cart of claim 1, wherein the base further comprises a plurality of base crossbar supports;
wherein each of the plurality of base crossbar supports comprises a through-hole disposed through one of the plurality of base sidewalls;
wherein the crossbar comprises a plurality of crossbars, wherein each of the plurality of crossbars is supported by two or more of the plurality of base crossbar supports.

14. The cart of claim 1, further comprising a reel spacer, wherein the reel spacer comprises a substantially cylindrical geometry and further comprises a reel spacer hole disposed through the substantially cylindrical geometry, wherein the reel spacer hole of the reel spacer is configured to receive the crossbar.

15. The cart of claim 1, further comprising a top platform, wherein the top platform is attached to each of the plurality of support beams.

16. The cart of claim 15, further comprising a handle attached to one or more of the top platform or two of the plurality of support beams.

17. The cart of claim 1, further comprising a plurality of wheels, wherein a quantity of the plurality of wheels is equivalent to a quantity of the plurality of support beams.

18. The cart of claim 1, wherein the crossbar comprises a plurality of crossbars, and wherein a quantity of the plurality of crossbars installed on the cart is adjustable by a user.

19. The cart of claim 18, wherein a spacing between two or more of the plurality of crossbars is adjustable by the user.

20. The cart of claim 1, further comprising a flexible grommet, wherein the flexible grommet comprises a first washer, a second washer and a hollow shank disposed between the first washer and the second washer;
wherein at least one of the plurality of crossbars is disposed through an interior space defined by the shank of the flexible grommet;
wherein the shank of the flexible grommet is disposed within one of the plurality of crossbar supports; and
wherein the flexible grommet prevents the crossbar from moving when the cart is transported.

21. The cart of claim 1, wherein the crossbar comprises a plurality of crossbars, and wherein a length of each of the plurality of crossbars is substantially equivalent.

22. The cart of claim 1, further comprising a top platform, wherein the top platform is attached to each of the plurality of support beams;
wherein the top platform comprises a plurality of tray sidewalls that extend above a surface of the top platform thereby forming a recessed portion with the top surface for storing items when transporting the cart and for preventing those items from falling off the cart during transport.
